(19) United States
(12) Patent Application Publication
(10) Pub. No.: US 2023/0317313 A1
(43) Pub. Date: Oct. 5, 2023

(54) ELECTRICAL CABLE HAVING A SURFACE FACILITATING THEIR INSTALLATION

(71) Applicant: NEXANS, Courbevoie (FR)

(72) Inventor: Carlos Fernando PEDRAZA SILVA, Santander (CO)

(21) Appl. No.: 18/125,068

(22) Filed: Mar. 22, 2023

(30) Foreign Application Priority Data
Mar. 31, 2022 (EP) 22305431.3

(51) Int. Cl. H01B 3/20; H01B 3/44; H01B 19/04; H01B 7/18; C10M 101/02

(52) U.S. Cl. CPC H01B 3/20; H01B 3/443; H01B 19/04; H01B 7/183; C10M 101/02; C10M 2203/1006; C10N 2020/02

(57) ABSTRACT

A lubricated cable includes at least one elongated electrical conductor, at least one outer layer surrounding said elongated electrical conductor, and at least one lubrication layer surrounding said outer layer. The lubrication layer is obtained from a lubrication composition having naphtha petroleum.

### RELATED APPLICATION

This application claims the benefit of priority from European Patent Application No. 22 305 431.3, filed on Mar. 31, 2022, the entirety of which is incorporated by reference.

### FIELD OF THE INVENTION

The present invention relates to a lubricated cable and a process for manufacturing the same.

### DESCRIPTION OF RELATED ART

Electrical cables generally comprise at least one conductor core and one or more layers surrounding said conductor core. The layers surrounding the conductor cores are usually made of polymeric material.

The outermost layer of electrical cables is in contact with the structure or environment in which they are installed. When the cables are installed in structures such as buildings or industrial sites, they are placed in internal sections of walls and ceilings or conduits.

For their installation in said structures, cables are pulled, moved and/or removed in order to be shifted or repaired. During such operations, frictions occur between the outermost layer (or surface) of the cable and, on one side, the structure surrounding the cables, and, on another side, the other cables which may be installed in the same structure. Such frictions may damage the cables, in particular by creating overheating on the cables and/or scratching of the surface of said cables.

In prior art, various modifications have been made mainly on the cables to avoid such frictions. In particular, the cables may be covered by a lubrication layer which allows to pull or move said cables while limiting frictions thereof with the environing structure and/or cables. Document U.S. Pat. No. 10,056,742 for example discloses a cable covered by a siloxane-based lubricant.

However, prior art lubricants may not be efficient enough to reduce frictions, may generate excesses and/or drips and may also attach environing dust.

Therefore, there is still a need to improve the surface of the cables in order to reduce the friction coefficient thereof while avoiding prior art drawbacks.

### OBJECTS AND SUMMARY

The purpose of the present invention is achieved by a lubricated cable comprising a cable, said cable possessing at least one elongated electrical conductor and at least one outer layer, notably at least one outer protective sheath, surrounding said elongated electrical conductor, said cable being coated by a lubrication composition comprising naphtha petroleum.

Another object of the present invention is a lubricated cable comprising at least one elongated electrical conductor, at least one outer layer, notably at least one outer protective sheath, surrounding said elongated electrical conductor and at least one lubrication layer surrounding said outer layer, notably said outer protective sheath, said lubrication layer being obtained from a lubrication composition comprising naphtha petroleum.

The lubricated cable of the present invention possesses a reduced coefficient of friction in order to reduce the pulling force that a user has to apply to the cable to install it in a structure such as a duct. In particular, the lubrication layer allows the surface of the lubricated cable to possess a reduced coefficient of friction. The lubricated cable of the present invention can therefore be easily installed, in particular in internal sections of walls and ceilings, ducts, conduits or any type of structure of a building or industrial sites. The reduced coefficient of friction of the cable allows to pull and/or move the cable in a structure or remove the cable from said structure while providing a limited effort. In addition, the reduced coefficient of friction of the lubricated cable makes it possible to prevent overheating of said cable, in particular of the surface of said cable, while the cable slides against the surface of a surrounding structure or cable.

According to a preferred embodiment, the lubrication composition is positioned at the surface of the outer layer, notably at the surface of the outer protective sheath, of the lubricated cable.

The lubrication layer is preferably the outermost layer of the lubricated cable.

The outer layer may be an outer protective sheath.

Lubrication Composition

Atmospheric distillation of crude oil enables to obtain several petroleum fractions, each characterized by specific properties such as composition, boiling point, specific gravity, kinematic viscosity, etc.

Compared to other petroleum fractions, such as mineral oil, light oil or heavy oil, the naphtha petroleum fraction is characterized by unique properties—notably in terms of kinematic viscosity, specific gravity, boiling point—which enables to confer unique properties to the lubrication composition, as described below.

Preferably, the lubrication composition forming the outermost lubrication layer of the lubricated cable of the present invention comprises from 50% to 100% of naphtha petroleum in weight relative to the total weight of the lubrication composition.

The lubrication composition may comprise at least 50% by weight of naphtha petroleum, preferably at least 60% by weight of naphtha petroleum, more preferably at least 70% by weight of naphtha petroleum, and even more preferably at least 80% by weight of naphtha petroleum, relative to the total weight of the lubrication composition.

In one embodiment, the lubrication composition comprises at least 90% by weight of naphtha petroleum, preferably at least 92% by weight of naphtha petroleum, more preferably at least 94% by weight of naphtha petroleum, and even more preferably at least 95% by weight of naphtha petroleum, relative to the total weight of the lubrication composition.

In one embodiment, the lubrication composition comprises at least 96% by weight of naphtha petroleum, preferably at least 97% by weight of naphtha petroleum, more preferably at least 98% by weight of naphtha petroleum, and even more preferably at least 99% by weight of naphtha petroleum, relative to the total weight of the lubrication composition.

The naphtha petroleum may be a hydrotreated naphtha petroleum. By “hydrotreated”, we mean hydrogen treated.

The naphtha petroleum may be selected from light naphtha petroleum, mid naphtha petroleum, heavy naphtha petroleum and mixtures thereof.

Preferably, the naphtha petroleum is a heavy naphtha petroleum.

Preferably, the naphtha petroleum used in the lubrication composition is a naphtha petroleum heavy and hydrotreated. In particular, it is a complex mixture of hydrocarbons obtained by treating a mineral oil fraction with hydrogen in the presence of a catalyst. The naphtha petroleum comprises preferably hydrocarbons with carbon numbers ranging from C6 and C13.

The naphtha petroleum has preferably the CAS number 64742-48-9.

The lubrication composition may comprise at least one fatty additive.

The fatty additive may be selected from fatty acids, notably saturated fatty acids or unsaturated fatty acids, such as for example mono- or poly-unsaturated fatty acids; fatty alcohols; fatty acid esters, such as for example mono-, di- or tri-glycerides; silicone oils; and mixtures thereof.

The fatty additive may be selected from vegetable oils and waxes, such as for example palm oil, palm olein, soybean oil, linseed oil, castor oil and mixtures thereof.

The fatty additive is preferably insoluble in water at ordinary temperature (25° C.) and at atmospheric pressure (760 mmHg) (i.e. solubility of less than 5 mg/mL, preferably less than 1 mg/mL and more preferably less than 0.1 mg/mL).

The fatty additive is preferably soluble in organic solvents at ordinary temperature (25° C.) and at atmospheric pressure (760 mmHg), such as chloroform, dichloromethane, carbon tetrachloride, ethanol, benzene, toluene, tetrahydrofuran (THF), liquid petroleum jelly or decamethylcyclopentasiloxane.

The lubrication composition may comprise at most 10% by weight of the fatty additive, preferably at most 8% by weight of the fatty additive, more preferably at most 6% by weight of the fatty additive, and even more preferably at most 5% by weight of the fatty additive, relative to the total weight of the lubrication composition.

In one embodiment, the lubrication composition comprises at most 4% by weight of the fatty additive, preferably at most 3% by weight of the fatty additive, more preferably at most 2% by weight of the fatty additive, and even more preferably at most 1% by weight of the fatty additive, relative to the total weight of the lubrication composition.

In one embodiment, the lubrication composition comprises:
at least 50% by weight of naphtha petroleum, preferably at least 60% by weight of naphtha petroleum, more preferably at least 70% by weight of naphtha petroleum, and even more preferably at least 80% by weight of naphtha petroleum, relative to the total weight of the lubrication composition, and
at most 10% by weight of the fatty additive, preferably at most 8% by weight of the fatty additive, more preferably at most 6% by weight of the fatty additive, and even more preferably at most 5% by weight of the fatty additive, relative to the total weight of the lubrication composition.

In one embodiment, the lubrication composition comprises:
at least 90% by weight of naphtha petroleum, preferably at least 92% by weight of naphtha petroleum, more preferably at least 94% by weight of naphtha petroleum, and even more preferably at least 95% by weight of naphtha petroleum, relative to the total weight of the lubrication composition, and
at most 10% by weight of the fatty additive, preferably at most 8% by weight of the fatty additive, more preferably at most 6% by weight of the fatty additive, and even more preferably at most 5% by weight of the fatty additive, relative to the total weight of the lubrication composition.

In one embodiment, the lubrication composition comprises:
at least 96% by weight of naphtha petroleum, preferably at least 97% by weight of naphtha petroleum, more preferably at least 98% by weight of naphtha petroleum, and even more preferably at least 99% by weight of naphtha petroleum, relative to the total weight of the lubrication composition, and
at most 4% by weight of the fatty additive, preferably at most 3% by weight of the fatty additive, more preferably at most 2% by weight of the fatty additive, and even more preferably at most 1% by weight of the fatty additive, relative to the total weight of the lubrication composition.

The lubrication composition may possess a kinematic viscosity, at 25° C., lower than 30 mm²/s (square millimeter per second), preferably lower than 15 mm²/s, more preferably lower that 10 mm²/s, and more preferably lower than 6 mm²/s.

In one embodiment, the lubrication composition possesses a kinematic viscosity, at 25° C., lower than 5 mm²/s, better still lower than 4 mm²/s, and even better still lower than 3 mm²/s.

The kinematic viscosity may be measured according to ASTM standard D445.

Such a viscosity allows the lubrication composition, once applied on the surface of the cable to form the outermost lubrication layer, to lower the friction coefficient of the cable, preferably of the surface of the cable.

The lubrication composition possesses a low viscosity to be easy to apply on the cable and to reduce the friction coefficient of the cable, preferably of the surface of the cable, once applied thereon.

Moreover, such a low viscosity enables to reduce or eliminate the collection or absorption of dirt from the environment during cable installation. Indeed, lubricated cables coated with known lubricants such as greases, e.g. greases based on petroleum jelly, make electrical installations difficult, as greases collect or absorb a lot of dirt from the environment due to its high viscosity.

The lubrication composition may have a specific gravity, at 20° C., in the range of 0.72 to 0.82, preferably of 0.73 to 0.81, more preferably of 0.74 to 0.80, and even more preferably of 0.75 to 0.79.

The specific gravity may be measured according to ASTM standard 891B.

The lubrication composition may have a boiling point lower than or equal to 250° C., preferably lower than or equal to 240° C., more preferably lower than or equal to 230° C., and even more preferably lower than or equal to 220° C.

In one embodiment, the lubrication composition has a boiling point lower than or equal to 210° C., better still lower than or equal to 200° C., and even better still lower than or equal to 190° C.

The lubrication composition may have a boiling point higher than or equal to 65° C., preferably higher than or equal to 70° C., more preferably higher than or equal to 80° C., and even more preferably higher than or equal to 90° C.

In one embodiment, the lubrication composition has a boiling point in the range of 65° C. to 250° C., preferably of 70° C. to 240° C., more preferably of 80° C. to 230° C., and even more preferably of 90° C. to 230° C.

In one embodiment, the lubrication composition has a boiling point in the range of 140° C. to 230° C., preferably of 150° C. to 220° C., more preferably of 160° C. to 210° C., and even more preferably of 160° C. to 205° C.

Preferably, the lubrication composition evaporates rapidly after being applied on the cable. This may enable to obtain a lubrication layer with controlled thickness along the cable.

Once applied on the cable, the lubrication composition forms a lubricated layer having a thickness which may range from 1 μm to 50 μm, preferably from 2 μm to 25 μm, and more preferably from 5 μm to 10 μm.

The thickness of the lubrication layer is optimized so as to reduce the friction coefficient of the cable without modifying the properties of the cable.

Preferably, the thickness of the lubrication layer is constant along the cable, i.e. that the thickness varies by less that 10% along the cable.

The lubrication composition may cover at least 60% of the outer layer, preferably at least 75% of the outer layer, and more preferably at least 90% of the outer layer.

Preferably, the lubrication composition is non-reactive to metals.

Cable

The lubricated cable may be an electrical cable.

The lubricated cable may be a low-voltage cable.

The elongated electrical conductor may be made from copper or aluminium.

The elongated electrical conductor is preferably made from copper.

The elongated electrical conductor may be solid or stranded.

The outer layer, notably the outer protective sheath, may be a thermoplastic layer (i.e. non-crosslinked layer), notably based on polyamide (also called nylon).

The outer layer, notably the outer protective sheath, may have a thickness in the range of 0.05 to 0.50 mm, preferably of 0.05 to 0.30 mm, more preferably of 0.05 to 0.20 mm, and even more preferably of 0.05 to 0.15 mm.

The lubrication layer may be in direct contact with the outer layer, notably the outer protective sheath.

The lubrication layer may have a thickness in the range of 1 to 50 μm, preferably of 1 to 25 μm, more preferably of 1 to 10 μm, and even more preferably of 1 to 8 μm.

In one preferred embodiment, the lubrication layer has a thickness in the range of 2 to 8 μm, and more preferably of 4 to 6 μm. For example, the lubrication layer has a thickness of 5 μm.

The lubricated cable may comprise at least one insulating layer surrounding the elongated electrical conductor, the outer layer, notably the outer protective sheath, surrounding said insulating layer.

Thus, the lubricated cable may comprise at least one insulating layer positioned between the elongated electrical conductor and the outer layer, notably the outer protective sheath.

The insulating layer may be a thermoplastic layer (i.e. non-crosslinked layer), notably based on polyethylene (PE), polypropylene (PP), polyvinyl chloride (PVC) and mixtures thereof.

The insulating layer is preferably based on polyvinyl chloride (PVC).

Alternatively, the insulating layer is a thermoset layer (i.e. crosslinked layer), notably based on crosslinked polyethylene (also called XLPE).

The insulating layer may have a thickness in the range of 0.20 to 1.50 mm, preferably of 0.25 to 1.45 mm, and more preferably of 0.30 to 1.40 mm.

In one preferred embodiment, the insulating layer has a thickness in the range of 0.20 to 0.90 mm, preferably of 0.25 to 0.85 mm, and more preferably of 0.30 to 0.80 mm.

In one preferred embodiment, the insulating layer has a thickness in the range of 0.30 to 0.60 mm, and more preferably of 0.35 to 0.55 mm. For example, the insulating layer has a thickness of 0.38 mm or 0.51 mm.

In one embodiment, the insulating layer is in direct contact with the elongated electrical conductor; the outer layer, notably the outer protective sheath, is in direct contact with the insulating layer; and the lubrication layer is in direct contact with the outer layer, notably the outer protective sheath.

According to a preferred embodiment, the cable of the present invention may be an electrical cable commonly used in building and industrial facilities and called THHN (“Thermoplastic High Heat-resistant Nylon coated”). According to this preferred embodiment, the cable comprises a copper elongated electrical conductor, an insulating layer surrounding said conductor and made of polyvinyl chloride (PVC), and an outer layer, notably an outer protective sheath layer, made of polyamide (also called nylon).

According to this preferred embodiment, the outer layer, notably the outer protective sheath layer, made of polyamide is coated by the lubrication composition.

In one preferred embodiment, the lubricated cable is a THHN electrical cable.

In one preferred embodiment, the elongated electrical conductor is made from copper, the insulating layer is based on polyvinyl chloride (PVC) and the outer layer, notably the outer protective sheath layer, is based on polyamide (also called nylon).

Advantageously, the coating of the cable by the lubrication composition to form the lubricated cable of the present invention does not modify the properties of the cable except the reduction of the friction coefficient of the cable. In particular, the coating of the cable by the lubrication composition does not modify the electrical properties, the resistance to fire and the mechanical properties such as for example flexibility, resistance to bending, aging properties, of the cable.

In addition, the lubricated cable of the present invention can maintain continuity of sliding during a certain period of time.

Independent of or in combination with what is disclosed above, a further object of the present invention is a lubricated cable comprising at least one elongated electrical conductor, at least one outer layer, notably at least one outer protective sheath, surrounding said elongated electrical conductor and at least one lubrication layer surrounding said outer layer, notably said outer protective sheath, said lubrication layer being obtained from a lubrication composition having a kinematic viscosity measured according to ASTM standard D445, at 25° C., lower than 6 mm²/s, preferably lower than 5 mm²/s, more preferably lower than 4 mm²/s, and even more preferably lower than 3 mm²/s.

Manufacturing Process

Another object of the present invention is a process for manufacturing a lubricated cable as previously described, said process comprising a step of applying the lubrication composition at the surface of the outer layer, notably at the surface of the outer protective sheath.

The lubrication composition may be applied on the cable by any method known by the skilled person in the art. Preferably, the lubrication composition is applied at the surface of the outer layer, notably at the surface of the outer protective sheath, by spraying.

The lubrication composition may be applied right after the formation of the outer layer, notably the outer protective sheath, or later.

The process further comprises a step of drying the lubrication composition once applied at the surface of the outer layer, notably at the surface of the outer protective sheath, to form the lubrication layer.

### DETAILED DESCRIPTION

### Examples

The present invention is described in further detail in the following examples which are not in any way intended to limit the scope of the present invention as claimed. In addition, it will appear to a person skilled in the art that various modifications may be made to the disclosed embodiments, and that such modifications are intended to be within the scope of the present invention.

### Example 1

In the example 1, a cable A comprises an elongated electrical conductor made of copper and having a diameter of 1.610 mm, said conductor being surrounded by an insulating layer made of PVC and having a thickness of 0.38 mm, said insulating layer being surrounded by a polyamide outer protective sheath having a thickness of 0.10 mm.

The cable A is coated by a lubrication composition commercialized by RichardsApex under the reference “V-4B CPD” to form a lubrication layer having a thickness of 5 μm, said lubrication layer surrounding the outer protective sheath.

The “V-4B CPD” lubrication composition comprises at least 50% by weight of naphtha petroleum, relative to the total weight of the lubrication composition; and possesses a kinematic viscosity, at 25° C., equal to 2.8 mm²/s (measured according to ASTM standard D445) and a specific gravity, at 20° C., equal to 0.77 (measured according to ASTM standard 891B).

### Example 2

In the example 2, a cable B comprises an elongated electrical conductor made of copper and having a diameter of 2.033 mm, said conductor being surrounded by an insulating layer made of PVC and having a thickness of 0.38 mm, said insulating layer being surrounded by a polyamide outer protective sheath having a thickness of 0.10 mm.

The cable is coated by a lubrication composition commercialized by RichardsApex under the reference “V-4B CPD” to form a lubrication layer having a thickness of 5 μm, said lubrication layer surrounding the outer protective sheath.

### Example 3

In the example 3, a cable C comprises an elongated electrical conductor made of copper and having a diameter of 2.558 mm, said conductor being surrounded by an insulating layer made of PVC and having a thickness of 0.51 mm, said insulating layer being surrounded by a polyamide outer protective sheath having a thickness of 0.10 mm.

The cable is coated by a lubrication composition commercialized by RichardsApex under the reference “V-4B CPD” to form a lubrication layer having a thickness of 5 μm, said lubrication layer surrounding the outer protective sheath.

### Comparative Example 1

In the comparative example 1, a cable D comprises an elongated electrical conductor made of copper and having a diameter of 1.610 mm, said conductor being surrounded by an insulating layer made of PVC and having a thickness of 0.38 mm, said insulating layer being surrounded by a polyamide outer protective sheath having a thickness of 0.10 mm.

### Comparative Example 2

In the comparative example 2, a cable E comprises an elongated electrical conductor made of copper and having a diameter of 2.558 mm, said conductor being surrounded by an insulating layer made of PVC and having a thickness of 0.51 mm, said insulating layer being surrounded by a polyamide outer protective sheath having a thickness of 0.10 mm.

Tests

To compare the friction coefficient of the cables coated with a lubrication composition (i.e. examples 1 to 3 according to the present invention) with the friction coefficient of the cables which are not coated with a lubrication composition (i.e. comparative examples 1 and 2), a pulling test was performed by pulling cables in a PVC pipe.

To perform this test, cables A to E having a length of 9 m are pulled from a PVC pipe. The maximum and minimum forces applied (force max and force min, respectively) are measured by a dynamometer.

The results are reported in Table 1.

TABLE 1

| | Lubrication | | |
|---|---|---|---|
| | composition | Force max | Force min |
| Cable A | Yes | 5.8 kgf | 4.6 kgf |
| Cable B | Yes | 6.7 kgf | 5.7 kgf |
| Cable C | Yes | 17.4 kgf | 5.8 kgf |
| Cable D | No | 9.2 kgf | 7.4 kgf |
| Cable E | No | 25.2 kgf | — |

These results show that a reduction of the pulling force applied is comprised between 20% and 40% when the cables possess a lubrication layer according to the present invention. Said lubrication layer therefore improves the friction coefficient of the cable.

1. A lubricated cable comprising: at least one elongated electrical conductor, at least one outer layer surrounding said elongated electrical conductor and at least one lubrication layer surrounding said outer layer, said lubrication layer being obtained from a lubrication composition comprising naphtha petroleum.

2. The lubricated cable according to claim 1, wherein the lubrication composition comprises at least 50% by weight of naphtha petroleum relative to the total weight of the lubrication composition.

3. The lubricated cable according to claim 1, wherein the lubrication composition possesses a kinematic viscosity, at 25° C., lower than 30 mm²/s.

4. The lubricated cable according to claim 1, wherein the lubrication composition has a specific gravity, at 20° C., in the range of 0.72 to 0.82.

5. The lubricated cable according to claim 1, wherein the lubrication layer has a thickness in the range of 1 to 50 μm.

6. The lubricated cable according to claim 1, wherein the outer layer is an outer protective sheath.

7. The lubricated cable according to claim 1, wherein the outer layer, notably the outer protective sheath, is a thermoplastic layer.

8. The lubricated cable according to claim 7, wherein the outer layer, notably the outer protective sheath, is based on polyamide.

9. The lubricated cable according to claim 1, wherein the outer layer, notably the outer protective sheath, has a thickness in the range of 0.05 to 0.50 mm.

10. The lubricated cable according to claim 1, wherein the lubrication layer is the outermost layer of the lubricated cable.

11. The lubricated cable according to claim 1, wherein the lubrication layer is in direct contact with the outer layer, notably the outer protective sheath.

12. The lubricated cable according to claim 1, wherein said lubricated cable comprises at least one insulating layer surrounding the elongated electrical conductor, the outer layer, notably the outer protective sheath, surrounding said insulating layer.

13. The lubricated cable according to claim 12, wherein the insulating layer is a thermoplastic layer.

14. The lubricated cable according to claim 13, wherein the insulating layer is based on polyvinyl chloride.

15. The lubricated cable according to claim 12, wherein the insulating layer has a thickness in the range of 0.20 to 1.50 mm.

16. A process for manufacturing a lubricated cable according to claim 1, wherein said process comprises a step of applying, notably by spraying, the lubrication composition at the surface of the outer layer, notably at the surface of the outer protective sheath.

17. The process according to claim 16, wherein said process further comprises a step of drying the lubrication composition once applied at the surface of the outer layer, notably at the surface of the outer protective sheath, to form the lubrication layer.
